(19) United States
(12) Patent Application Publication
(10) Pub. No.: US 2021/0312782 A1
(43) Pub. Date: Oct. 7, 2021

(54) MAN LOCATION AND MAN OVERBOARD DETECTION SYSTEM

(71) Applicant: BLACKWATCH.TECH INC., Yarmouth (CA)

(72) Inventors: Matthew d'Entremont, Lakeview (CA); Jonathan Raimund Skjelmose, Overton (CA)

(73) Assignee: BLACKWATCH.TECH INC., Yarmouth (CA)

(21) Appl. No.: 17/219,918

(22) Filed: Apr. 1, 2021

(30) Foreign Application Priority Data
Apr. 2, 2020 (CA) 3077773

(51) Int. Cl. G08B 21/08

(52) U.S. Cl. CPC G08B 21/088; G08B 21/086

(57) ABSTRACT

A detection system is provided. The detection system comprises a plurality of anchor RF transmitter/receiver modules for being mounted to a structure such that they are placed in a fixed spatial relationship with respect to each other. At least a portable RF transmitter/receiver module is adapted for RF communicating with the anchor RF transmitter/receiver modules. At least a processor adapted for: determining a location of the portable RF transmitter/receiver module based on the RF communication of the same with at least two anchor RF transmitter/receiver modules; determining if the location of the portable RF transmitter/receiver module is inside or outside a predetermined boundary; and, generating an alarm signal if the location of the portable RF transmitter/receiver module is outside the predetermined boundary, the alarm signal being indicative of the location of the portable RF transmitter/receiver module.

### FIELD OF THE INVENTION

The present invention relates to marine safety systems, and more particularly to a man overboard detection system for detecting and indicating a man overboard situation and a location thereof.

### BACKGROUND OF THE INVENTION

While fishing vessels are at sea, there is a chance that a crew member may fall overboard into the ocean without anyone noticing, especially in bad weather conditions. If the fall has not been detected quickly, it is difficult and dangerous to find and rescue the missing crew member and it is well possible that the missing crew member will never be found. Furthermore, the time the missing crew member stays in the water greatly effects the severity of the outcome of the man overboard situation. For example, in cold water such as the water of the North Atlantic a crew member that has fallen overboard can die within minutes from hypothermia.

It is well known that the fatality rate of crew members of commercial fishing vessels is much higher than that of other workers with the leading cause being the crew member falling overboard. More than 50% of man overboard situations are not witnessed by anyone and, therefore, most of them are not found in an initial search, likely resulting in the death of the missing crew member.

Even if a man overboard situation is witnessed, there is a delay in the response that may lead to the death of the crew member that has fallen overboard, since the witness has first to report to the captain before other crew members can get instructions where to start the search and rescue operation.

It is desirable to provide a man overboard detection system that senses and indicates substantially immediately a man overboard situation.

It is also desirable to provide a man overboard detection system that senses and indicates a location of a man overboard situation.

It is also desirable to provide a man overboard detection system that senses and indicates the crew member involved in a man overboard situation.

It is also desirable to provide a man overboard detection system that senses and indicates a respective location of all crew members.

### SUMMARY OF THE INVENTION

Accordingly, one object of the present invention is to provide a man overboard detection system that senses and indicates substantially immediately a man overboard situation.

Another object of the present invention is to provide a man overboard detection system that senses and indicates a location of a man overboard situation.

Another object of the present invention is to provide a man overboard detection system that senses and indicates the crew member involved in a man overboard situation.

Another object of the present invention is to provide a man overboard detection system that senses and indicates a respective location of all crew members.

According to one aspect of the present invention, there is provided a detection system. The detection system comprises a plurality of anchor RF transmitter/receiver modules for being mounted to a structure such that they are placed in a fixed spatial relationship with respect to each other. At least a portable RF transmitter/receiver module is adapted for RF communicating with the anchor RF transmitter/receiver modules. At least a processor adapted for: determining a location of the portable RF transmitter/receiver module based on the RF communication of the same with at least two anchor RF transmitter/receiver modules; determining if the location of the portable RF transmitter/receiver module is inside or outside a predetermined boundary; and, generating an alarm signal if the location of the portable RF transmitter/receiver module is outside the predetermined boundary, the alarm signal being indicative of the location of the portable RF transmitter/receiver module.

According to the aspect of the present invention, there is provided a detection system. The detection system comprises a plurality of anchor RF transmitter/receiver modules for being mounted to a structure such that they are placed in a fixed spatial relationship with respect to each other. At least a portable RF transmitter/receiver module is adapted for RF communicating with the anchor RF transmitter/receiver modules. At least a processor adapted for: determining a location of the portable RF transmitter/receiver module based on the RF communication of the same with at least two anchor RF transmitter/receiver modules; determining if the location of the portable RF transmitter/receiver module is inside or outside a predetermined boundary; and, generating an alarm signal if the location of the portable RF transmitter/receiver module is outside the predetermined boundary, the alarm signal being indicative of the location of the portable RF transmitter/receiver module. The detection system further comprises a central control module having a processor adapted for receiving an RF signal from each of the at least a portable RF transmitter/receiver module.

According to the aspect of the present invention, there is provided a detection method. A plurality of anchor RF transmitter/receiver modules are mounted to a structure such that they are placed in a fixed relation with respect to each other. At least a portable RF transmitter/receiver module communicates with the anchor RF transmitter/receiver modules. At least a processor determines a location of the portable RF transmitter/receiver module based on the RF communication of the same with at least two anchor RF transmitter/receiver modules, determines if the location of the portable RF transmitter/receiver module is inside or outside a

predetermined boundary, and generates an alarm signal if the location of the portable RF transmitter/receiver module is outside the predetermined boundary. The alarm signal is indicative of the location of the portable RF transmitter/receiver module.

The advantage of the present invention is that it provides a man overboard detection system that senses and indicates substantially immediately a man overboard situation.

A further advantage of the present invention is that it provides a man overboard detection system that senses and indicates a location of a man overboard situation.

A further advantage of the present invention is that it provides a man overboard detection system that senses and indicates the crew member involved in a man overboard situation.

A further advantage of the present invention is that it provides a man overboard detection system that senses and indicates a respective location of all crew members.

### BRIEF DESCRIPTION OF THE DRAWINGS

A preferred embodiment of the present invention is described below with reference to the accompanying drawings, in which:

FIGS. 1a to 1d are simplified block diagrams illustrating in top views in an example implementation on a vessel a detection system according to a preferred embodiment of the invention;

FIG. 2 is a simplified block diagram illustrating two-way ranging employed in the detection system according to the preferred embodiment of the invention;

FIGS. 3a and 3b are simplified block diagrams illustrating in top views components of the detection system according to the preferred embodiment of the invention;

FIG. 4 is a simplified block diagram illustrating in a perspective view a portable module of the detection system according to the preferred embodiment of the invention;

FIG. 5 is a simplified block diagram illustrating a central control module of the detection system according to the preferred embodiment of the invention; and,

FIGS. 6a and 6b are simplified block diagrams illustrating display screens of the detection system according to the preferred embodiment of the invention.

### DESCRIPTION OF THE PREFERRED EMBODIMENT

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

While the description of the preferred embodiments hereinbelow is with reference to a detection system for detecting and indicating a man overboard situation and a location thereof, it will become evident to those skilled in the art that the embodiments of the invention are not limited thereto, but are also adaptable for various other applications such as, for example, tracking children in daycare, tracking elderly with dementia, or tracking livestock.

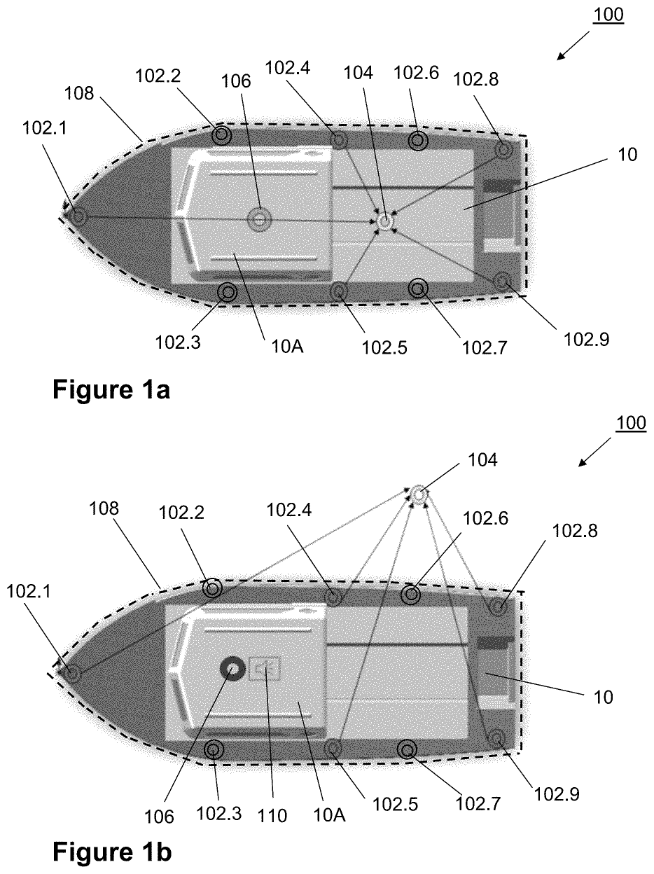

Referring to FIGS. 1a to 1d, a detection system for detecting and indicating a man overboard situation and a location thereof 100 according to a preferred embodiment of the invention is provided. The detection system 100 comprises a plurality of anchor Radio Frequency (RF) transmitter/receiver modules, for example, 9 anchor modules 102.1-102.9, mounted to the gunwale of a vessel 10, for example, a fishing vessel, such that they are placed in a fixed spatial relationship with respect to each other. In FIGS. 1a to 1d the dashed line 108 is used to illustrate the perimeter of the vessel 10. For example, the relative location of each anchor module 102 creates the rough outline of the vessel 10. The actual dimensions of the vessel 10 are then set relative to the fixed positions of the anchor modules (e.g. the end of the stern is 35 cm past the left stern anchor module 102.9). The anchor modules 102.1- 102.9 are installed in fixed locations of the vessel 10 and are fixed relative to each other in location. This fixed setup of the anchor modules 102 remains as the vessel moves at sea or in waves.

The detection system 100 further comprises, typically, a plurality of portable RF transmitter/receiver modules 104 such that each crew member of the vessel 10 is wearing one portable module 104 associated with him/her. It is noted that only one portable module 104 is shown in FIGS. 1a to 1d for simplicity. Each portable module 104 is adapted for RF communicating with the anchor modules 102.1-102.9. Based on the RF communication of the portable module 104 with at least two anchor modules 102, as indicated by the dashed arrows in FIGS. 1c and 1d, a location in x, y, z coordinates is determined and transmitted to listener 106A of central control module 106, as indicated by the dashed block arrow in FIGS. 1c and 1d. Preferably, each portable module 104 is associated with a unique identifier which is transmitted together with the location information. After receipt of the location information of the portable module 104 it is determined if the location of the portable module 104 is inside or outside the perimeter 108. If the portable module 104 is determined to be inside the perimeter 108, as illustrated in FIGS. 1a and 1c, the crew member associated therewith is deemed to be safe. If the portable module 104 is determined to be outside the perimeter 108, as illustrated in FIGS. 1b and 1d, the crew member associated therewith is deemed to be overboard and a ‘MAN OVERBOARD’ alarm signal is generated. Preferably, the alarm signal is indicative of the location of the portable module 104.

It is noted that a margin may be added to the perimeter 108 when determining if the portable module 104 is inside or outside the perimeter 108, for example, when the portable module 104 is worn on a crew member's wrist or as a pendant, to avoid false alarms when the crew member associated therewith reaches or leans, respectively, over the outside of the vessel 10.

Alternatively, the anchor modules 102 are placed in a small grid on top of a smaller surface such as, for example, the top of the wheelhouse 10A deck. The perimeter 108 of the vessel 10 is then provided relative to the location of the anchor modules 102 placed in the small grid for the detection system 100 to identify the perimeter 108 of the vessel 10.

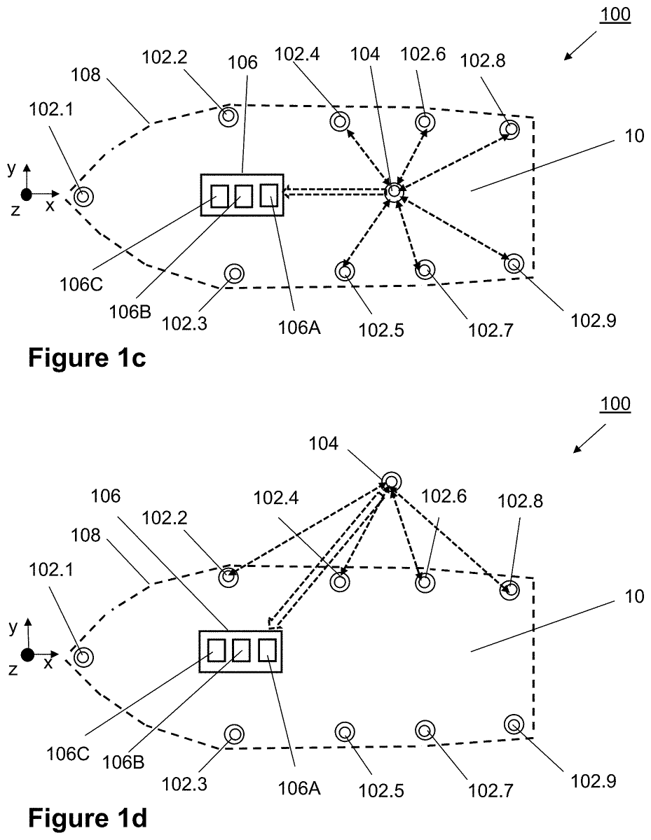

Preferably, the detection system 100 is implemented using Ultra-WideBand (UWB) technology. UWB is a RF technology that uses a very large portion of the radio spectrum for short-range communications in a low energy level. It is widely applied for target sensor data collection, precise locating, and tracking. UWB transmissions generate radio energy at specific time intervals occupying a large bandwidth, thus enabling pulse-position or time modulation to transmit information. Through determination of Time of Flight (ToF) between the portable module 104 and at least two of the anchor modules 102 the distance between the module 104 and the at least two of the anchor modules 102 is determined. Preferably, the distance is determined using double-sided Two-Way Ranging (TWR) as illustrated in FIG. 2.

Further preferably, the anchor modules 102 and the portable modules 104 are adapted to form a Real-Time Location System (RTLS) that uses the distance between each module to calculate the precise location in three-dimensions, x,y, and z. Each portable module 104 collects information about anchor modules 102 by listening to the Beacon messages that are continuously sent out from the anchor modules 102. Each of the anchor modules 102 at a respective known physical location is always sending a beacon message. Each portable module 104 creates a list of anchor modules 102 from which it already received the positions and then calculates distances to each of the anchor modules 102 on the list, based on its current position (if a portable module 104 does not know its position it will use 0,0,0). Each portable module 104 then decides which anchor modules 102 to choose for the next measurement using one of the following criteria:

1) if possible choose an anchor module 102 from each quadrant, i.e. the portable module 104 is surrounded by the anchor modules 102 with whom it will range with. The portable module 104 is inside the polygon created by the selected anchor modules 102; or,

2) select the anchor modules 102 which are nearest to the portable module 104.

The portable module 104 continues using the selected anchor modules 102 until it leaves the polygon or measurement with the selected anchor modules 102 is no longer possible (TWR failed or collision detected).

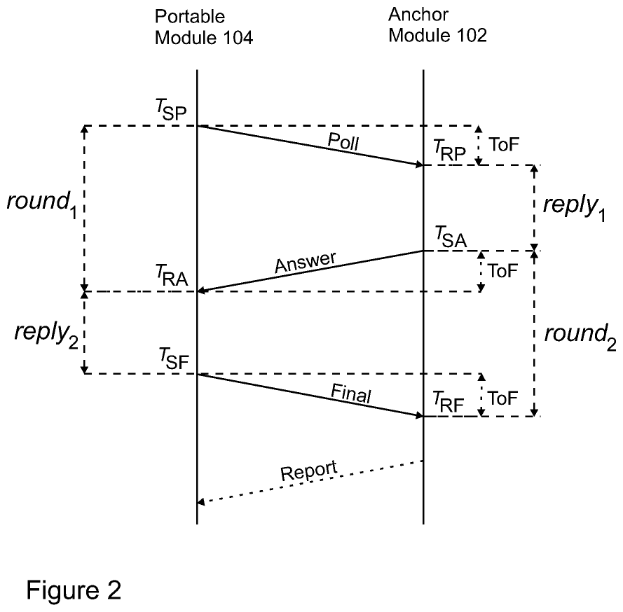

In an example implementation, as illustrated in FIGS. 3a and 3b, each portable module 104 comprises the following components:

a Printed Circuit Board (PCB) 112 that carries a commercially available UWB module 114 and a UWB transmitter/receiver 116, for example, a ‘Decawave’ Ltd. UWB Transceiver IC using 38.4 MHz reference crystals and 6.8 Mbps data rates;

a 5V wireless charger 128; and,

a 3.7V lithium battery (not shown).

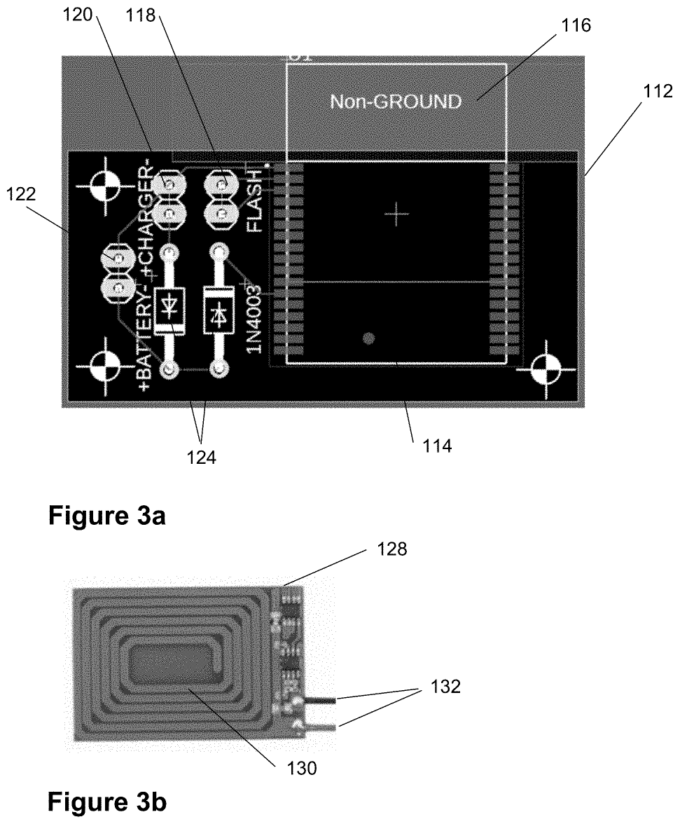

The port 118 is for loading the program into the module 114 and debugging using, for example, J-Link flash. The battery is 3.7V with maximums 4.25V. The required power supply of the module is ranging from 2.8V to 3.6V, a 1N4003 diode 124 is added to drop the voltage down by 0.7V to avoid overcharging the battery connected via port 120. When the voltage of battery drops below 3.4v (over 80% of capacity is consumed), a status indicator will show “Lose Connection” as a charging or low-battery reminder. The port 122 connects to inductive receiver coil 130 of wireless charger 128 via port 132. In the example implementation a 5V wireless charger 128 is used to charge a 3.7V lithium battery which is capable of charging a 2000 mAh battery in 8 hours within 5 mm distance. Preferably, the components of the portable module 104 are encapsulated in a sealed enclosure and can be attached to: a work-boot 20 (as illustrated in FIG. 4); life jacket; watch strap; belt; etc.

Optionally, the portable module 104 comprises an emergency button 134 enabling the respective crew member to send a signal when in need for assistance, for example, due to injury or being trapped/crushed by a shifted load.

Further optionally, the portable module 104 comprises a screen for displaying, for example, the location of a crew member in distress and/or the locations of other crew members.

The anchor modules 102 are provided in a similar manner as the portable modules 104. It is noted that the wireless charger 128 may be omitted by directly connecting the anchor modules 102 to the onboard electrical system of the vessel 10.

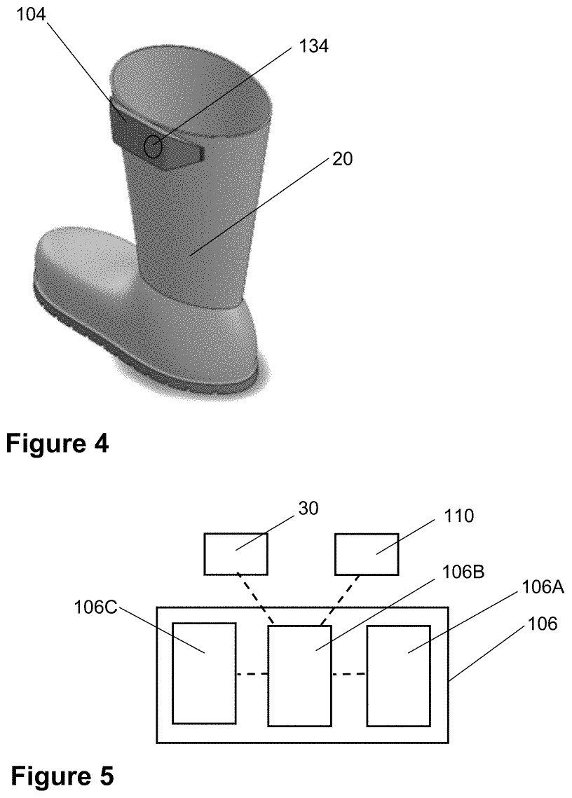

The listener 106A is constantly gathering wireless communications from the anchor modules 102 and the portable modules 104. In particular, the listener 106A receives messages of locations of each portable module 104. The gathered information is communicated directly to the central computing module 106B connected thereto, as illustrated in FIG. 5. The listener 106A is implemented, for example, using a ‘Decawave’ Ltd. UWB Transceiver IC.

The central computing module 106B is implemented using, for example, a commercially available Raspberry Pi 3b computer. The central computing module 106B collects the data, calculates distances and logs location of each portable module 104, receives user input data and provides information via Human-Machine Interface (HMI) 106C, for example, a touch screen, connected thereto, and drives visual/audible alarm device 110 connected thereto. The central computing module 106B is programmed using, for example, Python programming language.

Preferably, the alarm device 110 comprises a combination of a speaker and a signal light. The speaker is, for example, a waterproof speaker controlled by the computing module 106B using PyGame music library, while the signal light is a three-colour industrial light with its colour mode being controlled using General Purpose Input/Output (GPIO) pins of thee Raspberry Pi computer. The alarm device is, for example, mounted to the top of the wheel house 10A. In operation the speaker will alarm the crew in case of a man overboard situation by providing an alarm sound together with the location information, for example, “Warning! Man overboard starboard”. This way, other crew members can quickly locate the missing crew member and start with rescue operations. Optionally, the alarm message also indicates which crew member is in distress.

Preferably, the system and signal light are adapted to indicate three types of status:

GREEN: everything is OK;

ORANGE: potential danger (Loose Connection), for example, when a crew member's portable module 104 is not detected for a predetermined time interval, which can be caused by an empty battery of the portable module 104 or the signal is blocked by metal when the crew member is in the cabin, requiring other crew members to check; and,

RED: immediate danger, for example, when a crew member has fallen overboard or a crew member's portable module 104 is not detected for a predetermined time interval in a danger area, such as the open area of the back of the vessel 10, requiring other crew members to immediately act.

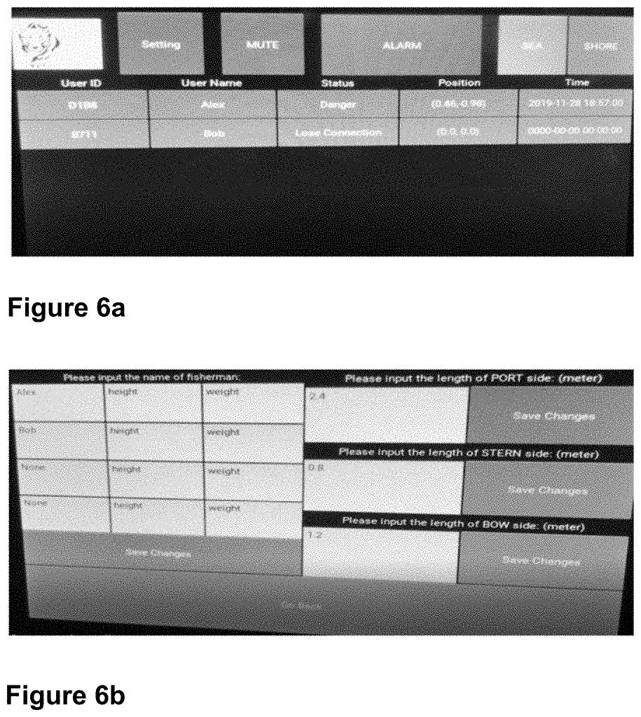

For example, the central computing module 106B is programmed such that the HMI 106C provides two screen pages: Main Screen and Setting Screen, as illustrated in FIGS. 6a and 6b, respectively. The Main Screen is the primary screen that contains each crew member's information such as: ID, name, status, location, and time. The ‘Setting’ button links to the Setting Screen. The ‘Sea/Shore’ button is a toggle button showing the current status of the vessel 10. When the vessel 10 is at sea, the detection system 100 is in operation and when the vessel 10 is at shore, the detection system 100 does not receive any information to prevent false alarms.

Optionally, when the portable modules 104 comprise the alarm button 134 the detection system 100 may be adapted to receive a signal when the alarm button 134 is pressed, for example, in situations when a crew member is in need for assistance due to injury or being trapped/crushed by a load during loading/unloading of the vessel 10. In case of immediate danger the ‘Alarm’ button turns red and the alarm device 110 is activated. If a rescue operation has already been started and the captain wants to mute the speaker, he can press the ‘Mute’ button which then turns red to indicate that the alarm status is on but has been muted. After the crew member has been rescued, indicated by the respective portable module 104 being located within the perimeter 108, the alarm is automatically turned off and indicated by the ‘Mute’ and the ‘Alarm’ button. Optionally, the captain is enabled to turn the alarm off, for example, by pressing the ‘Alarm’ button.

Below the buttons, each crew member's information is displayed in a scrollable manner such as, for example:

User ID: The ID of the portable module 104, unique and pre-set during installation;

User Name: The name of crew member that is carrying this portable module 104;

Status: There are three status: Online, Danger and Lose Connection;

Position: Area of the vessel 10 where the crew member is located such as back of the vessel 10, middle section of the vessel 10, or bow section 10, to enable to easily locate the crew member; and,

Time: This is the last connected time, if the crew member is not connected for more than, e.g. 30 seconds, then the crew member's status will become Lose Connection.

Optionally, the central computing module 106B is adapted to display first aid instructions on the Main Screen.

The Setting Screen enables provision of information regarding the crew members such as, for example, name, height, and weight of each crew member as well as the dimensions of the vessel 10 which are provided during installation of the detection system 100.

Preferably, the detection system 100 is connected to an existing Chart Plotter 30 of the vessel 10. Typically, Chart Plotters have a button or contact switch that is used to manually send the Man Overboard signal to the coast guard. The detection system 100 automatically closes the contact switch of the Chart Plotter when a Man Overboard situation is detected. Optionally, the detection system 100 also provides height and weight information of the crew member that has fallen overboard for drift calculation.

Further optionally, the detection system 100 is adapted to keep a log file recording each crew member's location with a time stamp for investigations if there is an accident.

The present invention has been described herein with regard to preferred embodiments. However, it will be obvious to persons skilled in the art that a number of variations and modifications can be made without departing from the scope of the invention as described herein.

What is claimed is:

1. A detection system comprising:
a plurality of anchor RF transmitter/receiver modules for being mounted to a structure such that they are placed in a fixed spatial relationship with respect to each other;
at least a portable RF transmitter/receiver module, the portable RF transmitter/receiver module being adapted for RF communicating with the anchor RF transmitter/receiver modules; and,
at least a processor adapted for:
determining a location of the portable RF transmitter/receiver module based on the RF communication of the same with at least two anchor RF transmitter/receiver modules;
determining if the location of the portable RF transmitter/receiver module is inside or outside a predetermined boundary; and,
generating an alarm signal if the location of the portable RF transmitter/receiver module is outside the predetermined boundary, the alarm signal being indicative of the location of the portable RF transmitter/receiver module.

2. The detection system according to claim 1 comprising a central control module having a processor adapted for receiving an RF signal from each of the at least a portable RF transmitter/receiver module.

3. The detection system according to claim 2 wherein each of the at least a portable RF transmitter/receiver module comprises a processor adapted for determining the location of the respective portable RF transmitter/receiver module and for providing an RF signal indicative thereof to the central control module.

4. The detection system according to claim 3 wherein each of the at least a portable RF transmitter/receiver module comprises a unique identification associated therewith and wherein the RF signal is indicative of the unique identification.

5. The detection system according to claim 1 wherein the anchor RF transmitter/receiver modules and the at least a portable RF transmitter/receiver module are adapted for transmitting/receiving UWB signals.

6. The detection system according to claim 5 wherein the anchor RF transmitter/receiver modules and the at least a portable RF transmitter/receiver module are adapted for determining the location of the portable RF transmitter/receiver module by performing TWR.

7. The detection system according to claim 2 wherein the central control module comprises an HMI.

8. The detection system according to claim 2 wherein the central control module is adapted for communicating with a GPS plotter.

9. The detection system according to claim 1 wherein the portable RF transmitter/receiver module comprises an emergency button.

10. A detection method comprising:
providing a plurality of anchor RF transmitter/receiver modules for being mounted to a structure such that they are placed in a fixed relation with respect to each other;
providing at least a portable RF transmitter/receiver module;
using the portable RF transmitter/receiver module RF communicating with the anchor RF transmitter/receiver modules;
determining a location of the portable RF transmitter/receiver module based on the RF communication of the same with at least two anchor RF transmitter/receiver modules;
determining if the location of the portable RF transmitter/receiver module is inside or outside a predetermined boundary; and,
generating an alarm signal if the location of the portable RF transmitter/receiver module is outside the predetermined boundary, the alarm signal being indicative of the location of the portable RF transmitter/receiver module.

11. The detection method according to claim 10 wherein the portable RF transmitter/receiver module RF communicate with the anchor RF transmitter/receiver modules using UWB signals.

12. The detection method according to claim 11 wherein the location of the portable RF transmitter/receiver module is determined by performing TWR.

13. The detection method according to claim 10 comprising indicating on a display the location of the portable RF transmitter/receiver module if the location of the portable RF transmitter/receiver module is outside the predetermined boundary.

14. The detection method according to claim 10 comprising indicating on a display the location of each of the at least a portable RF transmitter/receiver module.

15. The detection method according to claim 10 comprising sending the alarm signal to a GPS plotter.

16. The detection method according to claim 15 wherein the alarm signal sent to the GPS plotter is indicative of weight and height of a wearer of the portable RF transmitter/receiver module.

17. The detection method according to claim 10 wherein the at least a portable RF transmitter/receiver module is provided with an emergency button and wherein an alarm signal is generated if the emergency button is pressed, the alarm signal being indicative of the location of the portable RF transmitter/receiver module.
